(19) United States
(12) Patent Application Publication
(10) Pub. No.: US 2025/0101050 A1
(43) Pub. Date: Mar. 27, 2025

(54) METHOD FOR PRODUCING ORGANOSILICON COMPOUND

(71) Applicant: YUKI GOSEI KOGYO CO., LTD., Tokyo (JP)

(72) Inventors: Shunta Takeguchi, Tokyo (JP); Yuki Kajiwara, Tokyo (JP); Minenari Asakura, Tokyo (JP)

(21) Appl. No.: 18/768,247

(22) Filed: Jul. 10, 2024

(30) Foreign Application Priority Data
Jul. 21, 2023 (JP) 2023-118916

(51) Int. Cl. C07F 7/18

(52) U.S. Cl. CPC C07F 7/188

(57) ABSTRACT

The object is to provide a method for producing an organosilicon compound having a trifluoromethanesulfonyloxy group (CF₃SO₃) such as di-tert-butylsilyl bis(trifluoromethanesulfonate), which does not generate harmful HCl gas, does not need to be performed at a high temperature of about the boiling point of trifluoromethanesulfonic acid (162° C.), and gives a good yield. The present invention is a method for producing an organosilicon compound of formula (II)

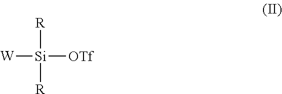

(wherein each R is the same or different and represents a C1-C6 linear or branched alkyl group, a C3-C8 cycloalkyl group, a phenyl group, or a combined group thereof; OTf represents a CF₃SO₃ group; and W represents a hydrogen atom or OTf)
wherein a di-substituted silane compound of formula (I)

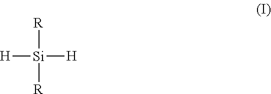

(wherein R is as defined in formula (I)) is reacted with trifluoromethanesulfonic acid.

### CROSS-REFERENCE TO RELATED APPLICATIONS

This application claims priority to Japan Patent Application Serial No. 2023-118916, filed on Jul. 21, 2023, the entire contents of which are incorporated herein by reference.

### TECHNICAL FIELD OF THE INVENTION

The present invention relates to a method for producing an organosilicon compound having a trifluoromethanesulfonyloxy group (CF₃SO₃).

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Organosilicon compounds having a trifluoromethanesulfonyloxy group (CF₃SO₃) such as di-tert-butylsilyl bis(trifluoromethanesulfonate) are known as selective protective reagents for polyhydroxy compounds (non-patent document 1).

For example, di-tert-butylsilyl bis(trifluoromethanesulfonate) is often used as a protective reagent for diols, such as the 3′,5′-dihydroxy group of nucleosides in amidite synthesis.

As a method for synthesizing organosilicon compounds having a trifluoromethanesulfonyloxy group (CF₃SO₃) such as di-tert-butylsilyl bis(trifluoromethanesulfonate), a method represented by the following reaction formula is described in non-patent document 2.

R₂SiHCl+2CF₃SO₃H→R₂Si(OSO₂CF₃)₂+H₂+HCl

(wherein R represents an isopropyl group or a t-butyl group)

In the above reaction, CF₃SO₃H is added dropwise at 22° C., followed by refluxing for 2 hours. Since the boiling point of CF₃SO₃H is 162° C., reflux is presumably carried out at 160° C. or more. The yields were indicated as 71% for di-tert-butylsilyl bis(trifluoromethanesulfonate) and 77% for diisopropylsilyl bis(trifluoromethanesulfonate).

This method is believed to be a conventional method as it is cited in other documents.

However, this method has problems that it generates harmful HCl gas, is performed at a high temperature of about the boiling point of trifluoromethanesulfonic acid (162° C.), and does not give a high yield.

### SUMMARY OF THE INVENTION

### Problem to be Solved by the Invention

The object is to provide a method for producing an organosilicon compound having a trifluoromethanesulfonyloxy group (CF₃SO₃) such as di-tert-butylsilyl bis(trifluoromethanesulfonate), which does not generate harmful HCl gas, does not need to be performed at a high temperature of about the boiling point of trifluoromethanesulfonic acid (162° C.), and gives a good yield.

### Means to Solve the Problem

As a result of extensive studies to solve the above problem, the present inventor has found that an organosilicon compound having one or two trifluoromethanesulfonyloxy groups (CF₃SO₃) can be produced without generating HCl gas, without using a high temperature, and with good yield, by using a di-substituted silane compound such as di-tert-butylsilane as a starting material.

That is, the present invention relates to:

(1) A method for producing an organosilicon compound of formula (II)

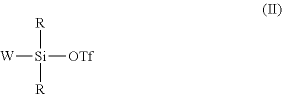

(wherein each R is the same or different and represents a C1-C6 linear or branched alkyl group, a C3-C8 cycloalkyl group, a phenyl group, or a combined group thereof; OTf represents a CF₃SO₃ group; and W represents a hydrogen atom or OTf)
wherein a di-substituted silane compound of formula (I)

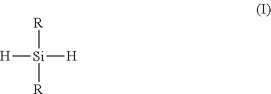

(wherein R is as defined in formula (I)) is reacted with trifluoromethanesulfonic acid, and specifically relates to:
   (2) The method for producing an organosilicon compound according to (1), wherein the organosilicon compound of formula (II) is di-tert-butylsilyl trifluoromethanesulfonate or di-tert-butylsilyl bis(trifluoromethanesulfonate).

### Effect of the Invention

Using the production method of the present invention, it is possible to produce an organosilicon compound having one or two trifluoromethanesulfonyloxy groups (CF₃SO₃) such as di-tert-butylsilyl bis(trifluoromethanesulfonate), without generating harmful HCl gas, without using a high temperature of about the boiling point of trifluoromethanesulfonic acid (162° C.), and with good yield.

### Mode of Carrying Out the Invention

### (Di-Substituted Silane Compound of Formula (I))

The starting material, a di-substituted silane compound of formula (I)

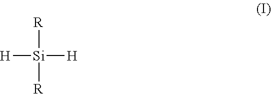

may be a commercially available product, or obtained by a known method, such as a hydrogen substitution of the chloro group of a di-substituted chlorosilane with a metal hydride such as lithium aluminum hydride.

In formula (I), each R is the same or different and represents a C1-C6 linear or branched alkyl group, a C3-C8 cycloalkyl group, a phenyl group, or a combined group thereof.

Examples of the C1-C6 linear or branched alkyl group include a methyl group, an ethyl group, an n-propyl group, an iso-propyl group, an n-butyl group, a sec-butyl group, an iso-butyl group, a tert-butyl group, an n-pentyl group, and an n-hexyl group.

Examples of the C3-C8 cycloalkyl group include a cyclopropyl group, a cyclobutyl group, a cyclopentyl group, a cyclohexyl group, a cycloheptyl group, and a cyclooctyl group.

Examples of the combined group thereof include a group combining a C1-C6 linear or branched alkyl group, a C3-C8 cycloalkyl group, and a phenyl group.

Examples of the group combining a C1-C6 linear or branched alkyl group with a C3-C8 cycloalkyl group include a cyclopropylmethyl group, a 2-cyclopropylethyl group, a cyclobutylmethyl group, a cyclohexylmethyl group, a 1-methyl-cyclopropyl group, and a 4-methyl-cyclohexyl group.

Examples of the group combining a C1-C6 linear or branched alkyl group with a phenyl group include a benzyl group, a phenethyl group, a 3-phenyl-n-propyl group, 2-methylphenyl, and a 4-methylphenyl group.

Specific examples include di-tert-butylsilane, di-iso-propylsilane, diphenylsilane, methylcyclohexylsilane, and methylphenylsilane.

### (Organosilicon Compound of Formula (II))

The organosilicon compound of formula (II)

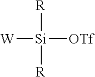

to be produced include compounds with one trifluoromethanesulfonyloxy group (CF₃SO₃) bonded and compounds with two trifluoromethanesulfonyloxy groups (CF₃SO₃) bonded.

Specifically, examples of the compound with one trifluoromethanesulfonyloxy group (CF₃SO₃) bonded include di-iso-propylsilyl trifluoromethanesulfonate, di-tert-butylsilyl trifluoromethanesulfonate, dicyclohexylsilyl trifluoromethanesulfonate, and diphenylsilyl trifluoromethanesulfonate, and examples of the compound with two trifluoromethanesulfonyloxy groups (CF₃SO₃) bonded include di-iso-propylsilyl bis(trifluoromethanesulfonate), di-tert-butylsilyl bis(trifluoromethanesulfonate), dicyclohexylsilyl bis(trifluoromethanesulfonate), and diphenylsilyl bis(trifluoromethanesulfonate).

### (Reaction)

In the reaction of the present invention, a compound with two trifluoromethanesulfonyloxy groups (CF₃SO₃) bonded is produced via a compound with one trifluoromethanesulfonyloxy group (CF₃SO₃) bonded, as represented by the following reaction formula.

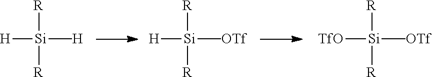

The produced amount of the compound with one trifluoromethanesulfonyloxy group (OTf) bonded and the compound with two trifluoromethanesulfonyloxy groups (OTf) bonded can be adjusted by adjusting the ratio of di-substituted silane of formula (I) and trifluoromethanesulfonic acid used, the reaction temperature, and the like.

The conditions for reacting the above di-substituted silane with trifluoromethanesulfonic acid are as follows.

When producing a compound where the organosilicon compound of formula (II) is in a bis(trifluoromethanesulfonate) form, the amount of di-substituted silane of formula (I) and trifluoromethanesulfonic acid used is not particularly limited as long as there are 2 moles or more of trifluoromethanesulfonic acid per 1 mole of di-substituted silane, and is usually 2 to 3 moles.

The reaction temperature is not particularly limited, but may be lower than the boiling point of trifluoromethanesulfonic acid (162° C.), and is usually 80 to 160° C.

When producing a compound where the organosilicon compound of formula (II) is in a mono(trifluoromethanesulfonate) form, the amount of di-substituted silane of formula (I) and trifluoromethanesulfonic acid used is usually 1 to 2 moles of trifluoromethanesulfonic acid per 1 mole of di-substituted silane. Alternatively, a compound in a mono(trifluoromethanesulfonate) form can be obtained by using 2 moles or more of trifluoromethanesulfonic acid per 1 mole of di-substituted silane, and reacting at a reaction temperature of 0 to less than 80° C., usually 0 to 60° C.

The reaction time can be set as appropriate according to the reaction temperature, the amount of reaction raw materials, and the like. The reaction can be performed under normal pressure.

No reaction catalyst is required.

The reaction of the present invention can be carried out without a solvent. A solvent can also be used, in which case a high-boiling solvent that does not affect the reaction is preferred. For example, aromatic hydrocarbon solvents such as toluene or xylene, and ethers such as butyl ether can be used.

The method for mixing the reaction raw materials is not particularly limited. The di-substituted silane of formula (I) and trifluoromethanesulfonic acid may be mixed and then heated, or the di-substituted silane of formula (I) can be added dropwise to trifluoromethanesulfonic acid, or conversely, trifluoromethanesulfonic acid can be added dropwise to the di-substituted silane of formula (I) while heating.

After the above reaction, the organosilicon compound of formula (II) can be isolated by atmospheric or vacuum distillation.

The organosilicon compound of formula (II), the target compound, can be identified by measuring the NMR spectrum, GC-MS spectrum, or the like.

Examples will be shown below, but the present invention is not limited to these Examples.

### EXAMPLE 1

476.4 g (3.17 mol) of trifluoromethanesulfonic acid was added to a reaction vessel, then 183.4 g (1.27 mol) of di-tert-butylsilane was added dropwise at an internal temperature of 125±5° C., and the mixture was stirred at the same temperature for 3.5 hours. After completion of the reaction, vacuum distillation was performed to give 463.1 g of di-tert-butylsilyl bis(trifluoromethanesulfonate) (83% yield, in terms of di-tert-butylsilane added).

### Example 2

100 mg (0.69 mmol) of di-tert-butylsilane and 322 mg (2.15 mmol) of trifluoromethanesulfonic acid were added to a reaction vessel, and the mixture was stirred at 40° C. for 4 hours. The results are shown in Table 1.

### EXAMPLE 3

The operations of Example 2 were repeated, except that the reaction temperature was set to 60° C. The results are shown in Table 1.

### EXAMPLE 4

The operations of Example 2 were repeated, except that the reaction temperature was set to 80° C. The results are shown in Table 1.

### EXAMPLE 5

The operations of Example 2 were repeated, except that the reaction temperature was set to 100° C. The results are shown in Table 1.

### EXAMPLE 6

The operations of Example 2 were repeated, except that the reaction temperature was set at 160° C. The results are shown in Table 1.

The compound numbers in Table 1 correspond to the numbers of the compounds in the following reaction formula.

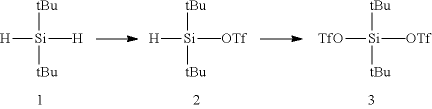

The ratio of Compounds 1 to 3 present in the reaction solution was calculated as an area percentage using GC.

TABLE 1

| | | Ratio of compound contained | | |
|---|---|---|---|---|
| | Reaction | in reaction solution (%) | | |
| | temperature | Compound 1 | Compound 2 | Compound 3 |
| Example 2 | 40° C. | n.d. | 99.8 | 0.2 |
| Example 3 | 60° C. | n.d. | 69.5 | 30.5 |
| Example 4 | 80° C. | n.d. | 4.9 | 95.1 |
| Example 5 | 100° C. | n.d. | 0.0 | 100.0 |
| Example 6 | 160° C. | n.d. | 0.2 | 99.8 |

The method using di-tert-butylchlorosilane is shown below as Comparative Examples.

### Comparative Example 1

250 mg (1.40 mmol) of di-tert-butylchlorosilane and 651 mg (4.34 mmol) of trifluoromethanesulfonic acid were added to a reaction vessel, and the mixture was stirred at 40° C. for 4 hours. The results are shown in Table 2.

### Comparative Example 2

The operations of Comparative Example 1 were repeated, except that the reaction temperature was set at 100° C. The results are shown in Table 2.

### Comparative Example 3

The operations of Comparative Example 1 were repeated, except that the reaction temperature was set at 140° C. The results are shown in Table 2.

### Comparative Example 4

The operations of Comparative Example 1 were repeated, except that the reaction temperature was set at 160° C. The results are shown in Table 2.

### Comparative Example 5

The operations of Comparative Example 1 were repeated, except that the reaction temperature was set at 170° C. The results are shown in Table 2.

The compound numbers in Table 2 correspond to the numbers of the compounds in the following reaction formula.

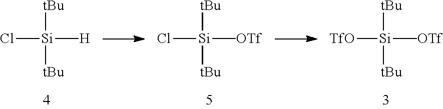

TABLE 2

| | | Ratio of compound contained | | |
|---|---|---|---|---|
| | Reaction | in reaction solution (%) | | |
| | temperature | Compound 4 | Compound 5 | Compound 3 |
| Comparative | 40° C. | 6.5 | 93.3 | 0.2 |
| Example 1 | | | | |
| Comparative | 100° C. | 0.0 | 88.9 | 11.1 |
| Example 2 | | | | |
| Comparative | 140° C. | 0.1 | 23.4 | 76.5 |
| Example 3 | | | | |
| Comparative | 160° C. | 0.2 | 12.7 | 87.1 |
| Example 4 | | | | |
| Comparative | 170° C. | 0.4 | 5.2 | 94.4 |
| Example 5 | | | | |

As described above, di-tert-butylsilyl bis(trifluoromethanesulfonate) could be obtained in high yield by the method of adding di-tert-butylsilane dropwise at 125±5° C. of Example 1.

Further, as shown in Examples 2 to 6, the production of the mono-OTf form (Compound 2) and di-OTf form (Compound 3) could be separated by controlling the temperature.

On the other hand, with the method using di-tert-butylchlorosilane described in non-patent document 2 (Comparative Examples), the mono-OTf form such as Compound 2 of the present invention was not obtained even by controlling the temperature, and only Compound 5 with the chloro group remaining was obtained. Further, in the Comparative Examples, the production rate of the di-OTf form (Compound 3) was low even when the temperature was increased.

### REFERENCES

1. Greene's Protective Groups in Organic Synthesis, Fifth edition, p 456-459, 2014
2. Tetrahydron Letters, Vol. 23, No 47, pp 4871-4874, 1982

What is claimed is:

1. A method for producing an organosilicon compound of formula (II) 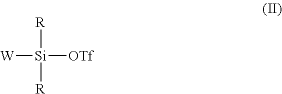
(wherein each R is the same or different and represents a C1-C6 linear or branched alkyl group, a C3-C8 cycloalkyl group, a phenyl group, or a combined group thereof; OTf represents a CF₃SO₃ group; and W represents a hydrogen atom or OTf)
wherein a di-substituted silane compound of formula (I) 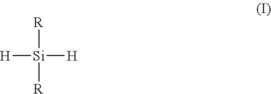
(wherein R is as defined in formula (II)) is reacted with trifluoromethanesulfonic acid.

2. The method for producing an organosilicon compound according to claim 1, wherein the organosilicon compound of formula (II) is di-tert-butylsilyl trifluoromethanesulfonate or di-tert-butylsilyl bis(trifluoromethanesulfonate).
